(19) United States
(12) Patent Application Publication
(10) Pub. No.: US 2013/0278491 A1
(43) Pub. Date: Oct. 24, 2013

(54) TRAVELING WAVE DIELECTROPHORETIC DISPLAYS

(71) Applicants: Gary Gibson, Palo Alto, CA (US); Jun Zeng, Palo Alto, CA (US)

(72) Inventors: Gary Gibson, Palo Alto, CA (US); Jun Zeng, Palo Alto, CA (US)

(73) Assignee: HEWLETT-PACKARD DEVELOPMENT COMPANY, L.P., Houston, TX (US)

(21) Appl. No.: 13/995,446

(22) PCT Filed: Dec. 20, 2010
(86) PCT No.: PCT/US2010/061286

§ 371 Date: Jun. 18, 2013

(51) Int. Cl. G09G 3/34

(52) U.S. Cl. CPC G09G 3/344
USPC 345/107

(57) ABSTRACT

A traveling wave dielectrophoresis display includes a display cell and a plurality of first particles contained within the display cell, the plurality of first particles having a first color. A plurality of electrodes in proximity to the display cell and generate a traveling wave dielectrophoresis field which distributes the plurality of first particles within the display cell to alter its optical characteristics.

### BACKGROUND

Reflective displays rely on the reflection of ambient light for visibility. The advantages of reflective displays include low power consumption and visibility in ordinary lighting conditions, including full sunlight. This allows devices which incorporate reflective displays to be used longer on a battery charge and to be viewed in a wide variety of lighting environments. However, reflective displays may also have a number of limitations including slow refresh rates, poor color intensity and contrast, or lack of color capability.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative reflective display, according to one example of principles described herein.

FIG. 2 is a graph of a Clausius-Mossotti function for an illustrative particulate colorant, according to one example of principles described herein.

FIGS. 3A-3D are diagrams of an illustrative display cell using traveling wave dielectrophoresis to control motion of particulate colorants, according to one example of principles described herein.

FIG. 4 a graph of a frequency operating region within a Clausius-Mossotti function of an illustrative particulate colorant, according to one example of principles described herein.

FIG. 5 is a graph of Clausius-Mossotti functions for various engineered particulate colorants, according to one example of principles described herein.

FIG. 6A is a graph showing illustrative dielectrophoresis operating regions for particulate colorants within a reflective display, according to one example of principles described herein.

FIG. 6B shows cross sectional diagrams of illustrative engineer particulate colorants, according to one example of principles described herein.

FIG. 6C-6F are cross sectional diagrams of display cells which show the selective motion of particulate colorants in a traveling wave dielectrophoretic display cell, according to one example of principles described herein.

FIG. 7 is a flowchart of an illustrative method for displaying color in a traveling wave dielectrophoresis display, according to one example of principles described herein.

Throughout the drawings, identical reference numbers designate similar, but not necessarily identical, elements.

### DETAILED DESCRIPTION

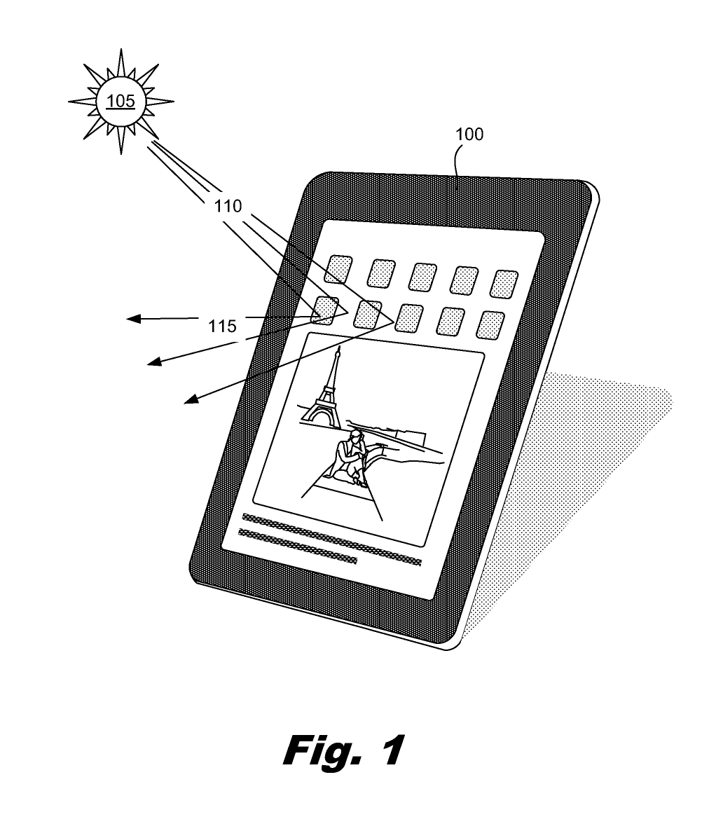

FIG. 1 is a diagram of an illustrative reflective display (100). Reflective displays rely on the reflection of ambient light for visibility. In this example, an external light source (105) produces incident light (110) which strikes the reflective display (100). The intensity, color and direction of reflected light (115) is controlled by cells within the display (100). The characteristics of the cells are selected to display the desired image. The desired image may include pictures, text, icons, and other images. The reflected light (115) is viewable by a user. The advantages of reflective displays include low power consumption and visibility in ordinary lighting conditions, including full sunlight. This allows devices which incorporate reflective displays to be used longer on a single battery charge and to be viewed in a wide variety of lighting environments. However, reflective displays may also have a number of limitations including slow refresh rates, poor color intensity and contrast, or lack of color capability. Additionally, many reflective display technologies use non-polar solvents. These non-polar solvents may create environmental issues if the solvent leaks from the display.

A traveling wave dielectrophoretic display is described below which uses dielectrophoresis as an operating principle to drive and control particulate-colorant based reflective displays. These traveling wave dielectrophoretic displays address all three issues raised above—color, high refresh rate, and environmental friendliness. Traveling wave dielectrophoresis coupled with particle design enables addressing of multiple particulate colorants simultaneously thereby facilitating full color. The illustrative design enables very high refresh rates and is operable with polar fluids, including aqueous liquids, rather than non-polar solvents. As used in the specification and appended claims, the term “traveling wave” refers to an alternating electric field (AC field). The term “dielectrophoresis” refers to a phenomenon in which a force is exerted on a dielectric particle when it is subjected to a non-uniform electric field.

In one example, the traveling wave dielectrophoretic display utilizes the imaginary component of the Clausius-Mossotti factor to realize the drive and control of the particulate colorants. As discussed below, the design of the particulate colorants produces different nonlinear functions of the imaginary component of the Clausius-Mossotti function for each color type. The particles can be engineered with a desired imaginary component of the Clausius-Mossotti function by selecting the particle material(s), distribution of materials in the particle structure, geometrical topology and geometrical dimension. This enables different mobility behavior associated with different color types under the same driving frequency. Different types of particles can be used as carriers for different colors. By selectively moving the various types of particulate colorants within cells in the display, a full-color reflective display can be achieved with a relatively simple single layer design. The electrodes which produce the traveling wave dielectrophoretic force are designed such that a very high refresh rate can be achieved to support video streaming.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

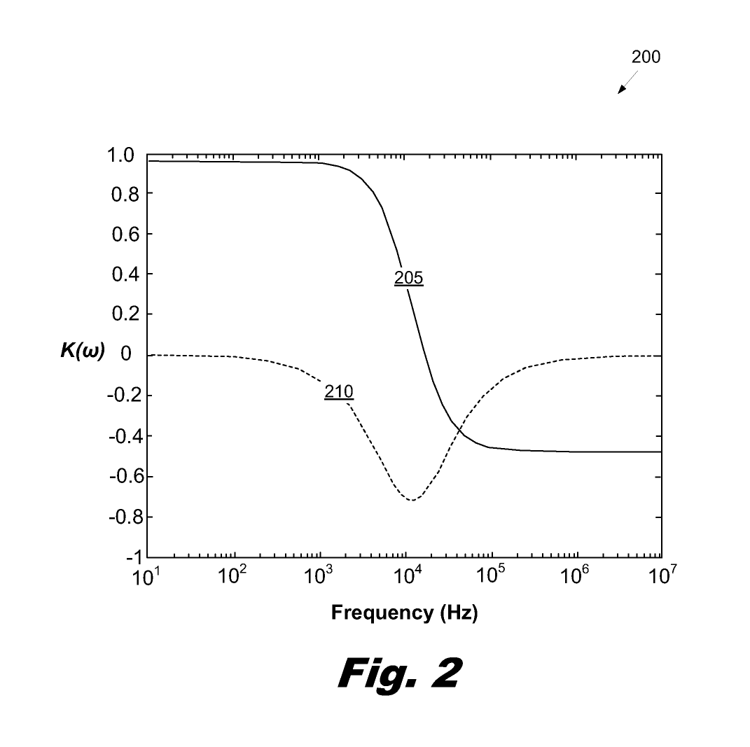

When a particle is exposed to an electric field, its response can be described by K(ω), the Clausius-Mossotti factor, an example of which is shown in FIG. 2. The Clausius-Mossotti factor is function of the frequency of the driving electric field and the particle's material properties. Consider a particle of radius r with complex permittivity ∈ₚ* suspended in a medium with complex permittivity ∈ₘ*. When exposed to an electric field E of frequency w, the dielectrophoretic (DEP) force exerted on the particle is:

F_{DEP}=2πr³∈ₘ∇|\vec{E}|²·K( ω̅) Eq. 1

\vec{E}=Re{\vec{E}(\vec{x})·e^{i\vec{φ}(\vec{x})}e^{i\vec{ω}t}} Eq. 2)

Note that φ is a phase angle vector that denotes the phase distribution in space. The time-averaged DEP force can be expressed as:

[symbol]

F_{DEP} [symbol] =F_{dcDEP}+F_{twDEP} Eq. 3

F_{dcDEP}=2πr³∈ₘ∇|\vec{E}|²·Re{K(\vec{ω})} Eq. 4

F_{twDEP}=2πr³∈ₘ(\vec{E}\vec{E}·I)·(∇\vec{φ})·Im{K(\vec{ω})} Eq. 5

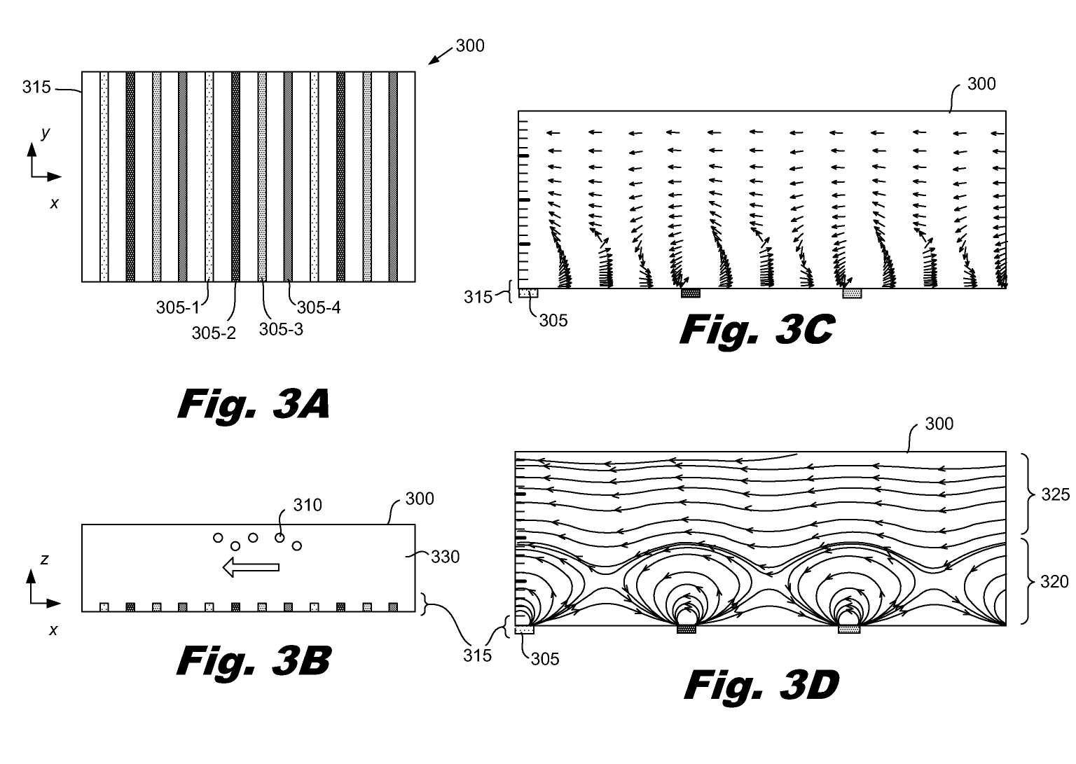

F_{dcDEP} denotes the forces originating from non-uniformity of the E-field. This is primarily a translational force, proportional to the real component of the Clausius-Mossotti factor K(ω). When Re{K(ω)}>0 (positive dielectrophoresis, or pDEP), this force drives particles to follow the convergence of the E-field (usually towards the electrodes); when Re{K(ω)}<0 (negative dielectrophoresis, or nDEP), the effect reverses. In one example, nDEP is applied to lift the particulate colorants away from the electrode array. This is further described and illustrated below with respect to FIGS. 3A-3D. Control of particle migration can be achieved via adjusting the driving frequency wand thus Re{K(ω)}. Furthermore, particles can be engineered so that Re{K(ω)} (the solid curve in FIG. 2) acquires desired profiles such that different particles behave differently under the same driving electric field. Thus the E-field strength and driving frequency w can be used as “tuning knobs” to independently influence the motion of different types of particles.

The force denoted F_{twDEP} (210) is shown in FIG. 2 by the dashed line and acts primarily in parallel to the electrode array as described below with respect to FIGS. 3A-3D. F_{twDEP} is influenced by the E-field strength, driving frequency ω, and by the gradient of the phase angle φ. The phase angle φ denotes the spatial phase shift of the electrical field and describes a traveling wave within the electric field. This provides an additional design parameter for the electrode configuration and control. Unlike F_{dcDEP}, F_{twDEP} is proportional to the imaginary component of the Clausius-Mossotti factor K(ω), Im{K(ω)}, rather than the real component Re{K(ω)}. The illustrative techniques described below are derived from particle engineering focusing on the imaginary component of Clausius-Mossotti function and its influence on the F_{twDEP} force described above in Eq. 5.

FIGS. 3A-3D illustrate the operation of traveling wave dielectrophoresis to control the migration of the particulate colorants. FIG. 3A shows an example cell (300) in a color display. The electrode array (315) is mounted to the bottom of the cell (300). Within this electrode array (315) there is an array of inter-digitated electrodes (305). According to one implementation, voltages are applied to the electrodes with a pre-defined, periodic, phase shift pattern (in this case, 90 degree apart). For example, a first electrode (305-1) may be excited by a voltage V₀e^{iωt+0}; a second electrode (305-2) may be excited by a voltage

$${V}_{0} {e}^{i ω t + \frac{π}{2 }} ;$$

a third electrode (305-3) may be excited by a voltage V₀e^{iωt+π}; and a fourth electrode (305-4) may be excited by a voltage

$${V}_{0} {e}^{i ω t + \frac{3 π}{2}} .$$

In this example, the phase shift of the voltage applied to a given electrode has a 90 degree phase shift with respect to the adjacent electrodes. This illustrative array of electrodes and the applied voltages generate the traveling wave electric field. The design parameters include the dimension of the electrodes, the size of the gap between neighboring electrodes, phase shift patterns between electrodes, applied voltages, and other parameters. These design parameters may be selected to provide the appropriate traveling wave dielectrophoresis field.

FIG. 3B shows the motion of particulate colorants (310) suspended in a fluid medium (330) in the cell (300). In this example, the traveling wave dielectrophoretic field generated by the electrode array (315) causes the motion of the particulate colorants (310) to the left through the fluid medium (330) as shown by the arrow.

In the example illustrated in FIGS. 3A-3D, the electrode array (315) lies in a single plane near the bottom of the cell (300). However, as used in the specification and appended claims, the term “electrode array” is used broadly and may be used to refer to electrodes in a variety of locations and orientations. For example, there could be two electrode planes, one mounted at the top of the cell and one mounted at bottom of the cell. This would effectively double the impact by, for instance, approximately doubling the driving forces and therefore the migration speed. Mounting electrodes on both the top and bottom of the cell may also approximately halve the thickness of the vortex region and therefore approximately halve the required lifting strength of F_{dcDEP} and increase the likelihood of the particles being lifted to the translational region. In one example, the top electrodes and bottom electrodes could be aligned. In another example, the top electrodes may be spatially shifted with respect to the bottom electrodes by half of the repeat distance or some other fraction of the repeat distance. The phase angle electrical field generated by the top electrodes may be aligned or shifted with respect to the bottom electrodes. For example, the phase angle of the top electrodes may be shifted 90 degrees with respect to the phase angle of the bottom electrodes. In other embodiments, the electrode array may include electrodes which are not in parallel planes.

FIG. 3C and FIG. 3D are two simulation results for a design employing just bottom electrodes. The length scale of the graphs is on the order of microns. FIG. 3C illustrates a cross-sectional portion of a display cell (300) with the resulting F_{twDEP} force vectors illustrated as arrows which create a vector field. The vector field clearly shows the translational forcing component slightly above the electrode array that drives the particulate colorants towards the left for the simulated dielectrophoretic field. FIG. 3D illustrates the velocity streamlines due to F_{twDEP}. These velocity streamlines clearly show the migration path of the particulate colorants towards the left as soon as the particles are lifted above the vortex region. As discussed above, F_{dcDEP} provides this lifting force.

Particles close to the vortex region (320) do not necessarily closely follow the streamlines shown in FIG. 3D due to the effect of F_{dcDEP}. The equation that governs the particle dynamics close to the vortex region under the influence of F_{dcDEP} can be described as

$$m \frac{d {\vec{u}}_{p}}{d t} = {\vec{F}}_{dcDEP} - 6 π μ ( {\vec{u}}_{p} - {\vec{u}}_{f} ) \qquad Eq . 6$$

where \vec{u}ₚ,\vec{u}_{f} are velocities of the particles and liquid flow, respectively. Considering F_{dcDEP} is primarily a lifting force with a dominant vertical component and assuming that flow surrounding the particles has a low Reynolds number, Eq. 6 can be separated into vertical (y) and horizontal components (x):

$$\begin{matrix}{u}_{p}^{x} \approx {u}_{f}^{x} & Eq . 7 \\ {u}_{p}^{y} \approx \frac{{ɛ}_{m} {r}^{2}}{3 μ} \{ ∇ {\vert E \vert}^{2} \} \{ Re \{ K ( ϖ ) \} \} & Eq . 8\end{matrix}$$

In the vortex region (320), the particle's path given by (uₚ^{x},uₚ^{Y}) deviates from (u_{f}^{x},u_{f}^{Y}) due to the presence of the lifting force, F_{dcDEP}, which moves the particles out of the vortex region (320) and into the translational region (325). It is shown below that this lifting force, F_{dcDEP}, is sufficient to support the ultra high refresh rates enabled by the traveling wave dielectrophoresis.

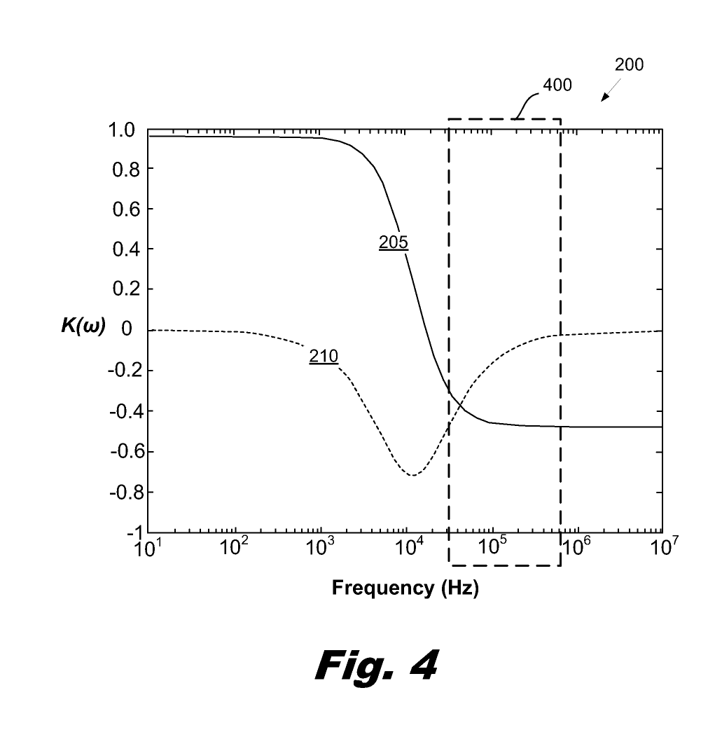

FIG. 4 illustrates the operating region (400) superimposed over the Clausius-Mossotti graph (200) associated with an illustrative particulate colorant. As discussed above, the Clausius-Mossotti function K(ω) has two components, a real component, Re{K(ω)}, which is illustrated as a solid line (205) and an imaginary component, Im{K(ω)}, which is illustrated as a dashed line (210). These curves (205, 210) vary as a function of frequency. The operating region (400) is selected so that the real component, Re{K(ω)}, is negative and provides sufficient lifting force for F_{dcDEP} to push particles out of the vortex region (320, FIG. 3D) and into the translational region (325, FIG. 3D). The operating region (400) simultaneously provides Im{K(ω)} of sufficient magnitude to ensure the efficiency of the traveling wave migration of particles in the fluid. In addition to display applications, the techniques of utilizing F_{dcDEP} to position the particles above and away from the electrode array and then utilizing F_{tWDEP} to translate the particles laterally could be used in a number of other applications.

In one example, the particulate colorants (310) may be neutral particles. Alternatively, charges or charged molecules may be attached to the particles. Binding charges to the particles can have a number of advantages, including stronger electrophoresis interactions with charged electrodes and more steric stability within the fluid medium. Where the particles have a net charge, a hybrid electrophoresis+traveling wave dielectrophoresis technique can be used to generate a color display and to provide more degrees of freedom for independently controlling the motion of multiple colorant species within the same cell.

The particles can be designed through engineering material selection, structural composition, geometrical topology and geometrical dimension such that different profiles of the imaginary component of the Clausius-Mossotti factor can be realized. Differences in the imaginary component of the Clausius-Mossotti factor enable different mobility behavior for different particles under the same driving frequency. When each type of particle is used as a carrier for a different color, full-color reflective display can be achieved.

Consider the expression for the Clausius-Mossotti factor:

$$K ( ϖ ) = \frac{{ɛ}_{p}^{*} - {ɛ}_{m}^{*}}{{ɛ}_{p}^{*} + 2 {ɛ}_{m}^{*}} ; {ɛ}^{*} = ɛ - \frac{i σ}{ϖ} \qquad Eq . 9$$

where the subscript p refers to the engineered particles and the subscript m refers to the surrounding medium. The permittivity ∈ and conductivity σ of each of the materials used to construct the various types of particles can be selected, together with the particles' structure, topology and dimensions to produce the desired ∈*ₚ. The selection of the desired ∈*ₚ and selection of the fluid medium with an appropriate ∈*ₚ results in the desired Re{K(ω)} and Im{K(ω)} components of the Clausius-Mossotti function.

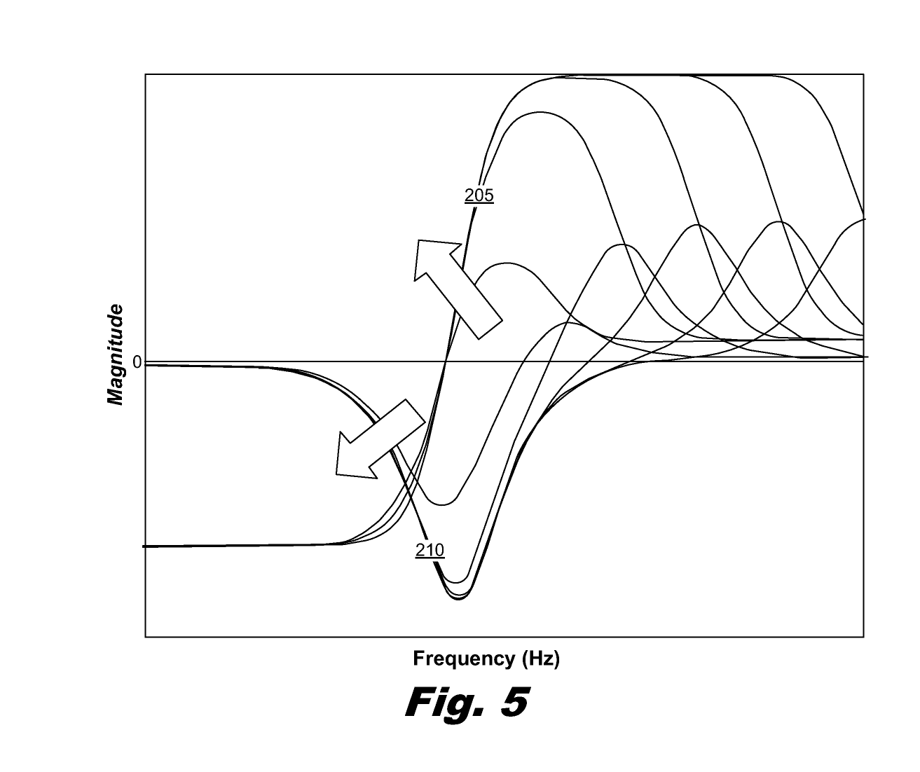

A simple example of an engineered particle is a spherical particle composed of two materials, that is, a core made of material A covered by a shell made of material B. FIG. 5 shows that these simple, bi-material engineered particles have distinctive frequency response curves (205, 210) that can deliver independent control of particles through dielectrophoresis. These different response curves for Re{K(ω)} and Im{K(ω)} are achieved through particle engineering and enable different colors to be selectively displayed within a cell. In the example shown in FIG. 5, material B (the shell material) is chosen such that it has much lower conductivity and permittivity compared to the core. In this example, the values for the conductivity can range from 1e⁻⁹ S/m to 100 S/m, and the permittivity can range from 2∈₀ to 100∈₀. These values are only illustrative and are not limiting. A variety of other configurations and materials can be used. For example, the shell may have higher conductivity and permittivity than the core. In another example of bi-material engineered particles, the shell may have one aspect of the electrical properties close to that of the core and have other aspects of the electrical properties different from that of the core. In general, the radii of the core and shell in such bi-material engineered particles may have different ratios.

More complex particle engineering and a much larger design space can be enabled if more than two types of materials are used to construct the particles. These different types of particles can be used as carriers for different colors. This enables the display of different colors within a single cell and enables full color in a relatively simple single layer display.

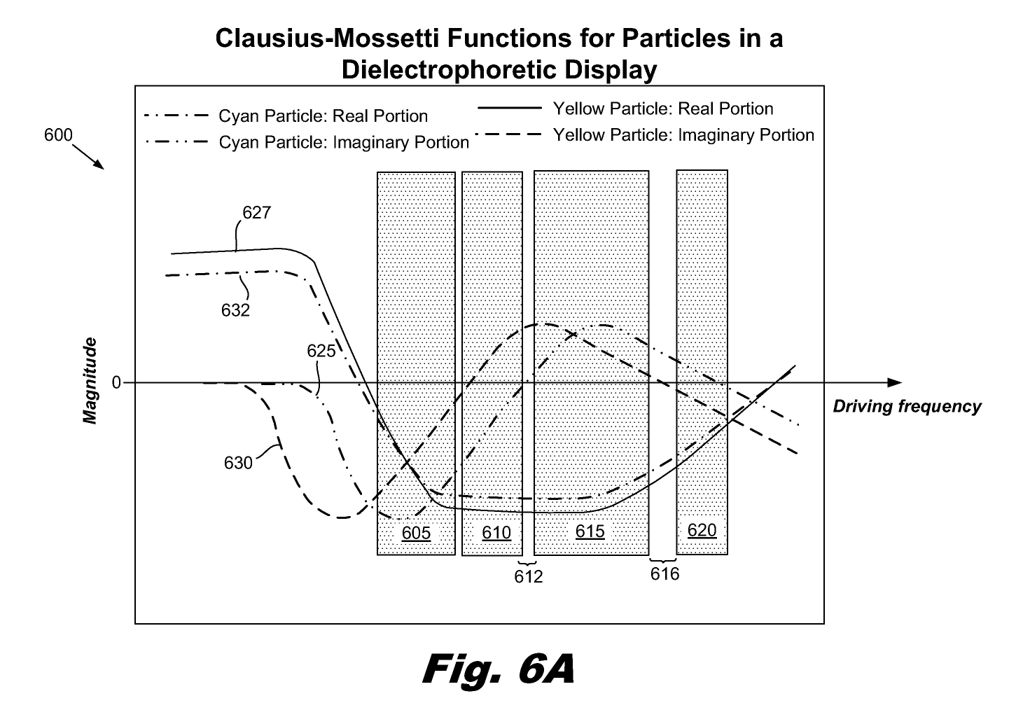

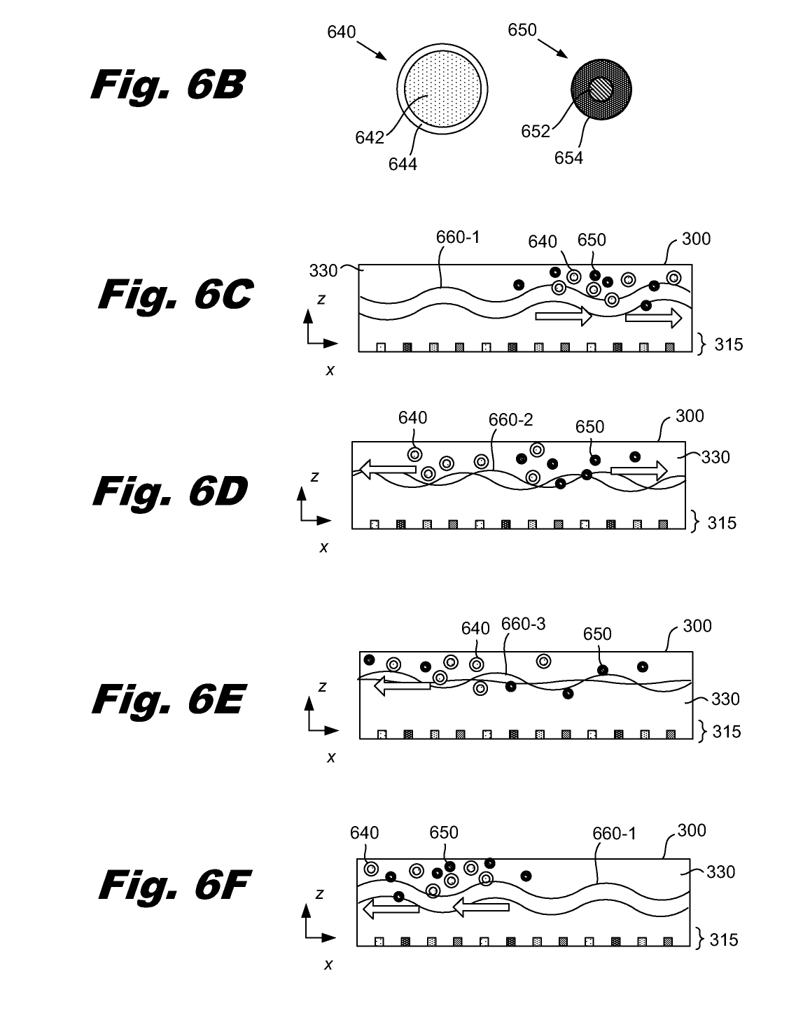

Recognizing the intrinsic nonlinearity associated with traveling wave dielectrophoresis, much more complex, richer (thus more powerful and more flexible) controls can be achieved by intentionally exploiting the nonlinearity through waveforms. FIG. 6A shows the Clausius-Mossotti curves for two different types of colored particles. For example, a first particle type may be cyan and exhibit a Re{K(ω)} behavior shown by the dash-dot line (632) and an Im{K(ω)} behavior shown by the dash-dot-dot line (625). The second particle type may be a yellow particle which exhibits a Re{K(ω)} behavior which is shown by the solid line (627). The Im{K(ω)} behavior of the yellow particle is shown by the dashed line (630). In this example, the real portion of the Clausius-Mossotti behavior for both particles is similar. This is shown by the close correlation between the two Re{K(ω)} curves (627, 632) for first particle type and second particle type. However, the Im{K(ω)} behavior of the two particle types has been engineered to be substantially different. The difference in the Im{K(ω)} frequency response of particles can be influenced by a variety of factors. As discussed above, this can be accomplished by through selectively designing the different particle types with an appropriate material selection, structural composition, geometrical topology and geometrical dimension.

FIG. 6B shows illustrative cross sectional diagrams of the yellow particle (640) and the cyan particle (650). The yellow particles (640) have a core shell structure as described above. The yellow core (642) and the yellow shell (644) are formed from different materials and may have a range of thicknesses. In this example, the core (642) is relatively large and the shell (644) is relatively thin. The cyan particle (650) has a core (652) which is formed from a different material than the yellow core (642) and is much smaller. The cyan shell (654) is thicker than the yellow shell (644). The overall size of the yellow particle (640) is larger than the cyan particle (650). Thus, the various particles which are included in the display can vary in size, shape, materials, structure, dielectric properties or other characteristics. Due to these differences the Clausius-Mossotti functions of the particles are different and can be tuned to provide a desired response. The examples given above are only illustrative particles which show that the particles may have these differences.

Now referring again to FIG. 6A, the difference in the imaginary portions of frequency response allows independent control of the motion and direction of the various types of particles. The shaded boxes (605, 610, 615, 620) illustrate a simplified control regime for a cell with which contains the two types of particles described above. In this example, the control regions are all located within the frequency range where the real portion of the Clausius-Mossotti function is negative for both particles. This is shown by the two Re{K(ω)} curves (627, 632) extending under the zero line on the graph in each control region. As discussed above, the real portion of the Clausius-Mossotti function provides the lifting force which moves particles out of the vortex region (320, FIG. 3D) and into the translation region (325, FIG. 3D).

The imaginary portion, Im{K(ω)}, of the function provides the translational force which moves the particles in the translation region (325, FIG. 3D). For purposes of explanation, it will be assumed that when the imaginary portion of the function for a given particle type is negative, the particles of that type will move to the right and when the imaginary portion of the function is positive particles of that type will move to the left.

In the first operating regime (605), the imaginary portion of the Clausius-Mossotti function for both types of particles is negative. Consequently, when particles are driven with frequencies which fall within the first operating regime (605), both types of particles move to the right. FIG. 6C shows both the yellow particles (640) and the cyan particles (650) being driven through the fluid (330) toward the right side of the cell (300) by the traveling wave dielectrophoretic field (660-1). As discussed above, the dielectrophoretic field (660-1) is created by the application of specific electrical signals to the electrode array (315). The electrical signals applied to the individual electrodes within the electrode array (315) can vary in amplitude, phase, shape, polarity, and other characteristics. These electrical signals are selected and applied to create the desired traveling wave dielectrophoretic field (660-1). The wavy lines which are used to illustrate the dielectrophoretic field (660) in FIGS. 6C-6F are only used to show the existence of the field, not to qualitatively or quantitatively describe the field. In general, the dielectrophoretic field (660) can vary both temporally and in three physical dimensions.

In the second operating regime (610, FIG. 6A), the imaginary portion of the function for the yellow particle is positive and the imaginary portion for the cyan particle is negative. FIG. 6D shows the yellow particles (640) moving to the left and the cyan particles (650) moving to the right.

At frequencies where one of the imaginary functions intersects the horizontal axis (zero-crossing points) and the other function is positive or negative, one type of particle will remain stationary and the other particle type will migrate. FIG. 6E shows an operating regime (612, FIG. 6A) in which the imaginary function (625, FIG. 6A) of the cyan particles (650) is at or close to zero and the imaginary function (630, FIG. 6A) for the yellow particles (640) is positive. Consequently, the yellow particles (640) move to the left and the cyan particles (650) remain stationary within the cell (300).

In a fourth operating regime (615, FIG. 6A) the functions for both particle types are positive and both particle types move to the left. This motion is illustrated in FIG. 6F. In the fifth operating regime (620, FIG. 6A), the function for the cyan particles (650) is positive and the function for the yellow particles (640) is negative. When particles are driven with frequencies in the fifth operating regime (620), the cyan particles (650) move to the left and the yellow particles (640) move to the right. These examples illustrate that by altering the driving frequency of the electrical field, the individual particle types can be selectively controlled.

Additionally or alternatively, multiple frequency dielectrophoresis may be used to enhance the mobility and control of the particles. Multiple frequency dielectrophoresis can be accomplished by driving spatially separated electrodes at different frequencies or by driving the same electrodes at two different frequencies. The spatial distribution of the different frequencies can be altered across one or more surfaces of a display cell to achieve the desired particulate motion and response time.

This system can be extended to provide the same level of targeted control over cells which contain particles of three or more types. By engineering the various particle types, their imaginary Clausius-Mossotti functions can be tuned to produce operating regimes which provide individual and/or collective control of the particle types. As discussed above, the combination of engineered particles and selectively generated traveling wave dielectrophoretic fields enables the display of different colors within a single cell and enables full color in a relatively simple single layer display. For example, where a cell contains yellow, cyan and magenta particles, the particles could be engineered so that one operating regime translates the yellow and cyan particles to the sides of the cell while leaving the magenta particles distributed throughout the cell. The color of the cell is then controlled by the incident light interacting with the magenta particles. Similarly, there may be an operating regime where only one type of particle is translated, leaving the other two types of particles distributed throughout the cell. The combined effect of the two types of particles distributed throughout the cell then dominates the color of the cell.

Calculations to estimate the performance of a simplified electrode geometry in a traveling wave dielectrophorises cell are given below. More complex electrode designs may use different distributions of the electrode size and electrode spacing. For instance, in FIG. 3A-3D the electrode size is smaller than the electrode spacing. In addition, the electrode size and/or electrode spacing are not necessarily constant, but may employ certain spatial distributions. To accurately quantify complex electrode designs, detailed simulations such as that shown in FIGS. 3A-3D are useful. However, a simplified approach allows for a closed form solution which provides a reasonable and conservative estimate of the performance of a cell. The closed form solution assumes that the electrodes have equal width and equal separation which is designated as d. Beginning with Eq. 5 above and plugging in d as a characteristic length, a simplified expression for F_{twDEP} can be given in terms of d.

$${F}_{twDEP} = 2 π {r}^{3} {ɛ}_{m} ( \vec{E} \vec{E} \cdot I ) \cdot ( ∇ \vec{φ} ) \cdot Im \{ K ( ϖ ) \} \approx - \frac{4 π {r}^{3}}{3} ( 3 {ɛ}_{m} ) Im \{ K ( ϖ ) \} {( \frac{π}{4 d} )}^{3} {( \frac{16 V}{{π}^{2}} )}^{2} ⇒ \vert 〈 {F}_{twDEP} 〉 \vert \approx 16 {{ɛ}_{m} ( \frac{r}{d} )}^{3} {V}^{2} \qquad Eq . 10$$

Further, the Stoke's drag on a particle can be estimated as F_{d}=6πμrU where U is the particles' velocity. This gives the equation that governs the particle dynamics.

$$\frac{4 π ρ {r}^{3}}{3} \frac{d U}{d t} = \vert 〈 {F}_{twDEP} 〉 \vert - {F}_{d} \qquad Eq . 11$$

This is a low-Reynolds number problem; therefore it can be assumed the particles reach terminal velocity rather quickly, that is,

$$U \approx \frac{8 {ɛ}_{m} {r}^{2} {V}^{2}}{3 π μ {d}^{3}} \qquad Eq . 12$$

Plugging in numbers, in SI units, produces a refresh frequency, f, for a travel distance of L,

$$f \approx \frac{U}{L} \approx \frac{8 {ɛ}_{m} {r}^{2} {V}^{2}}{3 π μ {d}^{3} L} \approx {( \frac{L}{d} )}^{3} \frac{{ɛ}_{m} {r}^{2} {V}^{2}}{μ {L}^{4}} \approx {( \frac{100 e - 6}{5 e - 6} )}^{3} \frac{( 1 e - 10 ) {( 500 e - 9 )}^{2} {( 40 )}^{2}}{( 1 e - 2 ) * {( 100 e - 6 )}^{4}} = 320 Hz \qquad Eq . 13$$

In general, any refresh frequency which is equal to or greater than refresh frequencies used in video display is sufficient. This simplified calculation indicates that very high refresh rates (at least 3× refresh frequencies used for supporting video streaming) are within reach for reasonable voltages and particles sizes. In some implementations, the voltage may range from below a volt to tens of volts and the particle size may range from tens to hundreds of nanometers. In this illustrative example, a voltage of 40 V, a particle size of 500 nm, a travel distance of 100 microns, and an electrode separation and width of 5 microns were used.

Next, the adequacy of F_{dcDEP} to lift the particles out of the vortex region and support the video streaming refresh rate that the traveling wave dielectrophoresis delivers can be estimated. Recall the particle's kinetic profile in the vortex region can be described as:

$$\begin{matrix}{u}_{p}^{x} \approx {u}_{f}^{x} & Eq . 14 \\ {u}_{p}^{y} \approx \frac{{ɛ}_{m} {r}^{2}}{3 μ} \{ ∇ {\vert E \vert}^{2} \} \{ Re \{ K ( ϖ ) \} \} & Eq . 15\end{matrix}$$

Assuming the height of the vortex region is on the order of d (this assumption is supported by the analysis presented in FIG. 3), the frequency that F_{dcDEP} can support—referred to as the lift frequency—can be seen to exceed the video streaming rates.

$${f}_{lift} \approx \frac{{u}_{p}^{y}}{d} \approx \frac{{ɛ}_{m} {r}^{2} {V}^{2}}{3 μ {d}^{4}} \approx \frac{( 1 e - 10 ) {( 500 e - 9 )}^{2} {( 40 )}^{2}}{3 * ( 1 e - 2 ) * {( 5 e - 6 )}^{4}} = 2133 Hz \qquad Eq . 16$$

F_{dcDEP} has sufficient strength to lift the particles out of the vortex region and into the translational region to support the refresh rate that the traveling wave dielectrophoresis can deliver.

The examples, graphs, diagrams, and values used above are given only as examples of possible implementations of the principles described herein. There are a variety of other configurations which could be used. For example, the display may be monochromatic and use only one type of particle. In other embodiments, the fluid within the cell may be colored and participate in the color changing mechanism. Similarly, the walls and floor of the cell may be colored, clear, or reflective. These and other variations of the principles described can be used to create a dielectrophoretic display with the desired characteristics.

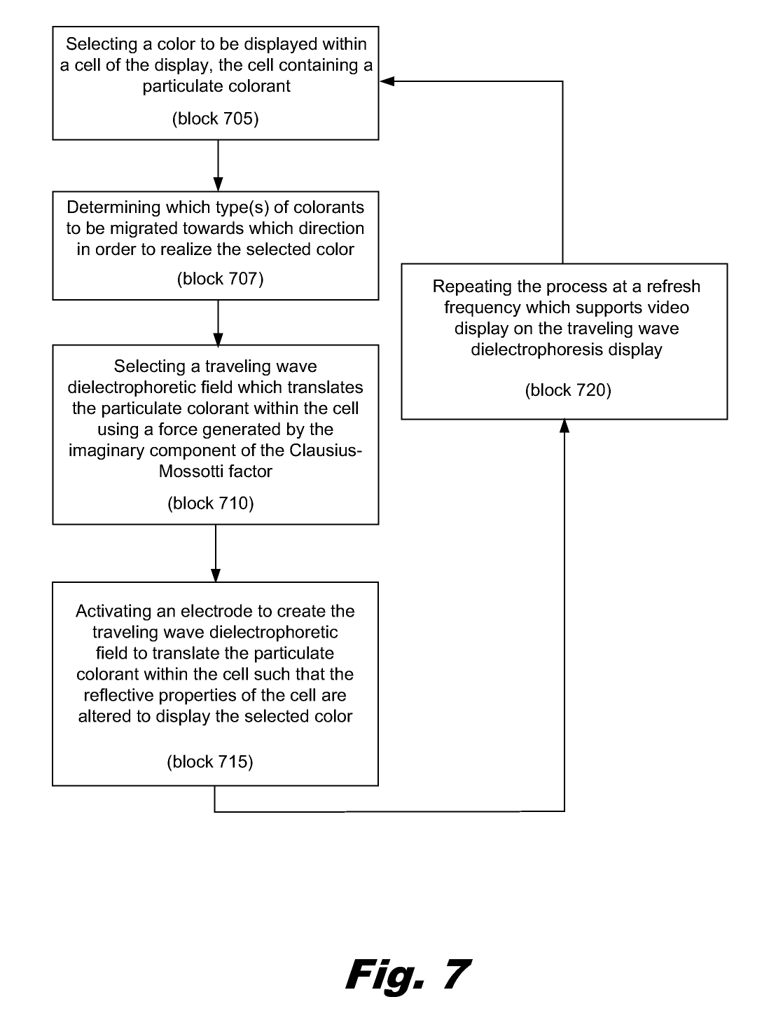

FIG. 7 is a flowchart of an illustrative method for displaying color in a traveling wave dielectrophoresis display. The method includes selecting a color to be displayed within a cell of the display which includes a particulate colorant (block 705). In some implementations the cell may contain at least three different types of particulate colorants, each of the three different types of particulate colorants having different profiles of the imaginary component of a Clausius-Mossotti factor. The desired motion of the various types of colorants within the cell is then determined so that the selected color is realized (block 707). A traveling wave dielectrophoretic field is selected to translate the particulate colorant(s) within the cell using a force generated by the imaginary component of the Clausius-Mossotti function (block 710) For example, the driving waveform may include a driving frequency or frequencies and a waveform created by sequential or parallel application of these frequencies at desired amplitudes. An electrode or a set of electrodes is then activated to create an electrical field with the selected driving frequency or frequencies. This traveling wave dielectrophoretic field translates at least one type of particulate colorant within the cell such that the reflective properties of the cell are altered to display the selected color (block 715). The method further includes repeating the process of selection of a color, selection of a driving frequency and activating an electrode at a refresh frequency which supports video display on the traveling wave dielectrophoresis display (block 720).

In conclusion, a traveling wave dielectrophoresis (AC dielectrophoresis) is used as an operating principle to drive and control particulate-colorant based reflective displays that can achieve full color and very fast refresh rates (for instance, to support video streaming). Traveling wave dielectrophoresis coupled with particle design enables independent simultaneous addressing of multiple particulate colorants, thereby enabling full color in simple single layer pixel architectures. The illustrative principles enable very high refresh rates and use of non-polar fluids, including aqueous liquids, rather than solvents.

The preceding description has been presented only to illustrate and describe embodiments and examples of the principles described. This description is not intended to be exhaustive or to limit these principles to any precise form disclosed. Many modifications and variations are possible in light of the above teaching.

1. A traveling wave dielectrophoretic display comprising:
a display cell;
a plurality of first particles contained within the display cell, the plurality of first particles having a first color;
a plurality of electrodes in proximity to the display cell; and
a traveling rave dielectrophoresis field generated by the plurality of electrodes at a first driving frequency, the traveling wave dielectrophoresis field distributing the plurality of first particles within the display cell to alter the optical characteristics of the display cell.

2. The display of claim 1, in which the first particles have negative real components of a Clausius-Mossotti function aver a range of driving frequencies.

3. The display of claim 1, in which the plurality of electrode is distributed across at least one surface of the display cell.

4. The display of claim 1, further comprising a plurality of second particles having a second color, in which the first particles and the second particles have different profiles of the imaginary components of the Clausius-Mossotti factor such that the first particles and the second particles exhibit different motion within the traveling wave dielectrophoresis field at the first driving frequency.

5. The display of claim 4, in which both the first particles and the second particles have negative real components of the Clausius-Mossotti factor over a range of driving frequencies.

6. The display of claim 4, in which the first particles move a first direction and second particles move in a second opposite direction in the traveling wave dielectrophoresis field at the first driving frequency.

7. The display of claim 4, in which first particles and second particles move in the same direction when the traveling wave dielectrophoresis field has a second driving frequency.

8. The display of claim 4, in which the first particles remain substantially stationary and second particles translate within the display cell when the traveling wave dielectrophoresis field has a third driving frequency.

9. The display of claim 4, further comprising a plurality of third particles having a third color.

10. The display of claim in which the first particles and second particles are electrically neutral.

11. The display of claim 4, in which the first particles and second particles have different profiles of the imaginary component of the Clausius-Mossotti factor, thereby enabling the first particles to exhibit different mobility behavior than the second particles in multiple operating regimes.

12. A full color reflective display comprising:
a cell;
a fluid medium contained within the cell;
colorant particles movably disposed within the fluid medium;
an electrode array in proximity to the cell; and
a dielectrophoretic field generated by application of an electrical waveform to the electrode array, the colorant particles exhibiting a response to the dielectrophoretic field;
in which motion of colorant particles within the fluid medium is independently controlled by altering the frequency of the dielectrophoretic field.

13. A method for displaying color in a traveling wave dielectrophoresis display, the method comprising:
selecting a color to be displayed within a cell of the display, the cell containing a particulate colorant;
selecting a traveling wave dielectrophoretic field which translates the particulate colorant within the cell using a force generated by the imaginary component of the Clausius-Mossotti factor; and
activating an electrode array to create the traveling wave dielectrophoretic field to translate the particulate colorant within the cell such that the reflective properties of the cell are altered to display the selected color.

14. The method of claim 13, further comprising repeating the selection of a color, selection of a traveling wave dielectrophoretic field, and activating an electrode array, at a refresh frequency which supports video display on the traveling wave dielectrophoresis display.

15. The method of claim 13, in which the cell of the display includes a vortex region and a translating region, the traveling wave dielectrophoretic field:
lifting the particulate colorant out of the vortex region using a force created by a real portion of a Clausius-Mossotti function; and
selectively translating the particulate colorant in the translating region using a force created by an imaginary portion of the Clausins-Mossotti function.
